(19) United States
(12) Patent Application Publication
(10) Pub. No.: US 2026/0285079 A1
(43) Pub. Date: Sep. 24, 2026

(54) Pencil, Shaft and Process for Production Thereof

(71) Applicant: STAEDTLER SE, Nürnberg (DE)

(72) Inventors: Andreas Thies, Adelsdorf (DE); Martin Jakob, Hallstadt (DE); Johannes Herbolsheimer, Obernzenn (DE)

(21) Appl. No.: 19/477,059

(22) PCT Filed: Apr. 15, 2024
(86) PCT No.: PCT/EP2024/025149

§ 371 Date: Oct. 20, 2025

(30) Foreign Application Priority Data
Apr. 28, 2023 (DE) 10 2023 111 014.4

(51) Int. Cl. B43K 19/14; A45D 40/20; C08G 63/08

(52) U.S. Cl. CPC B43K 19/14; A45D 40/20; C08G 63/08

(57) ABSTRACT

Pencil (1) having a shaft (3), wherein the shaft (3) comprises a shaft base material having a base formulation, wherein the base formulation comprises 50% to 80% by weight of PLA, PLA copolymer and/or PLA blend, 20% to 50% by weight of further polymers, plasticizers, waxes/lubricants, further additives such as adhesion promoters, stabilizers etc., colorants, in particular pigments, organic and/or inorganic fillers as shaft fillers, wherein the shaft base material is foamed and/or comprises pores.

The invention relates to a pencil with the features of the preamble of claim 1. Furthermore, the invention relates to a shaft for writing implements, painting implements, drawing implements and/or cosmetic pencils as claimed in claim 12 and a process for the production of the pencil and/or the shaft with the features of claim 13.

Wood-cased pencils, in which the lead is surrounded or sheathed by naturally grown wood, have been known for a long time. In recent years, the price of quality high-grade woods has increased owing to the lack of availability of wood, which has a direct effect on pencil production costs. In addition, comparatively large natural timber resources are being consumed for the production of pencils.

In response to this, the production of lead pencils or lead casings and leads from polymers by extrusion has become widespread. Polystyrene (PS) is an example of a base polymer for the base material of the shaft. Polystyrene has the advantages of good availability, easy processability and good mechanical properties for the resulting shaft.

Against this background, the published document DE 10 2008 034 013 B4 proposes the use of a wood substitute material for the shaft of a pencil, wherein the wood substitute material is based on a polymeric binder.

An extruded pencil of this type is also known, for example, from EP 0 505 262 B1, which arguably constitutes the closest prior art. The pencil described therein consists of foamed polystyrene in the casing and a flexible polystyrene-bonded lead.

The objective of the present invention is to propose a pencil which constitutes a sustainable alternate to the prior art, wherein at the same time, the functional characteristics of the pencil, in particular the sharpening capability and bending strength, should be retained. This objective is achieved by means of a pencil with the features of claim 1, a shaft for writing implements, painting implements, drawing implements and/or cosmetic pencils as claimed in claim 12 and a process for the production of the pencil and/or the shaft with the features of claim 13. Preferred or advantageous embodiments of the invention are defined in the dependent claims, the description below as well as the accompanying drawing.

The objective of the invention is a pencil, wherein the pencil has a shaft.

Optionally, the pencil has a lead, wherein the shaft preferably surrounds the lead concentrically and/or coaxially and wherein the lead is disposed with the shaft in a manner which is resistant to displacement and/or non-displaceable. In particular, the lead is permanently and inextricably fixed in the shaft and/or not able to be detached without being destroyed. As an example, the lead may optionally be bonded with the shaft via intermediate layers in a material-bonding, force-fitting and/or interlocking manner.

In particular, the pencil is constructed as a straight cylinder, wherein the base area of the cylinder or the cross sectional area can, for example, be round, oval, triangular, quadrangular, pentagonal, hexagonal or polygonal. Alternatively, the pencil may be twisted or bent in shape.

In particular, the pencil can be sharpened. As an example, it can be sharpened with a pencil sharpener, for example a coloured pencil sharpener, lead pencil sharpener, sharpening machine or cosmetic pencil sharpener, wherein a conical tip of the pencil is created or remade by the ablation of material separated from the shaft and from the lead.

The shaft has a shaft base material, wherein preferably, at least 60% by weight, preferably at least 80% by weight and in particular at least 98% by weight or even 100% by weight of the shaft consists of the shaft base material. As an alternative or in addition, preferably, at least 80% of the cross sectional area, preferably at least 90% of the cross sectional area and in particular at least 98% of the cross sectional area or even 99% of the cross sectional area is formed by the shaft base material. In particular, the shaft base material is in a foamed, porous form.

In particular, the shaft has a shaft body produced from the shaft base material. The shaft body is annular in cross section, for example in the form of a circular ring. In particular, the inner contour may be circular and/or the outer contour may have any configuration, for example round, oval, triangular, quadrangular, pentagonal, hexagonal or polygonal.

In the context of the invention, it is proposed that the shaft base material is produced in two steps. In a first step, the components of the base formulation are mixed. A base mixture with the base formulation is formed. In a second step, the base mixture with the base formulation is mixed with a foaming additive. A production mixture is formed. The production mixture is heated thermally above the decomposition temperature of the foaming additives and shaped into the shaft. The shaft base material is produced. The shaft base material is foamed and contains pores. The gaseous components of the shaft base material can be ignored in the total weight of the shaft base material. The ratios of the components in the base formulation are substantially retained in the shaft base material.

The base formulation comprises:

| | |
|---|---|
| 50 to 80% by weight | PLA and/or PLA copolymer |
| 20 to 50% by weight | further polymers, plasticizers, waxes/lubricants, |
| | other additives such as adhesion promoters, |
| | stabilizers, etc, colorants, in particular |
| | pigments, organic and/or inorganic fillers. |

In addition to olefins, the term “further polymers” may also encompass polybutylene succinate (PBS). In particular, the proportion of PBS is less than 8% by weight, preferably less than 5% by weight, in particular 0% by weight. The base formulation can be PBS-free.

In particular, the base formulation comprises the following proportions of the components:

| | |
|---|---|
| 50 to 80% by weight | PLA and/or PLA copolymer |
| 0 to 10% by weight | polybutylene succinate (PBS) |
| 0 to 25% by weight | further polymers |
| 0.1 to 25% by weight | plasticizers |
| 0 to 10% by weight | waxes/lubricants |
| 0.1 to 10 by weight | other additives such as adhesion promoters, |
| | stabilizers, etc |
| 0 to 10% by weight | colorants, in particular pigments |
| 0 to 40% by weight | organic and/or inorganic fillers as shaft fillers |

In order to produce the shaft of the pencil or of the writing implement, painting implement, drawing implement and/or cosmetic pencil, the components of the base formulation are mixed and, as the base mixture of the base formulation, mixed with foaming additives and foamed and shaped as the production mixture. The shaft base material is produced. The foaming additives in this regard are preferably added to the base mixture of the base formulation in situ in the final extrusion in order to specifically obtain their action only during the shaping of the end product.

In order to produce the shaft base material, a production mixture is used. The production mixture has the following components:

| | |
|---|---|
| 90 to 99% by weight | base mixture with the base formulation |
| 1 to 10% by weight | foaming additives |

The proportion of foaming additives used is dependent on the one hand on the content of the at least one reactive component in the additive, on the other hand on the desired reduction in density in the final product. Furthermore, specific process parameters (temperature, pressure, melt viscosity, polymer dwell time in the extruder or injection moulding unit, etc.) additionally determine this content.

The foaming additives are no longer contained in the final product in their original form because they have deliberately been thermally decomposed and an expanding gas has been released which foams the base mixture with the base formulation. Thus, pores are left behind in the plastic mass which are due to the use of foaming additives. The entire base mixture of the base formulation is foamed, so that because of the foaming, the details regarding the ratios of the components of the base formulation as percentages do not undergo any extensive changes.

### PLA/PLA Copolymer

PLA is an appellation for polylactic acid, which in particular can be termed polylactide. In particular, PLA is also registered in the Chemical Abstracts Service under number CAS: 9051-89-2. The properties of the PLA as a polymer can vary somewhat, depending on the number of monomers in the polymer. The PLA can also be present as a PLA copolymer or PLA blend. The PLA copolymer contains PLA as the first component, and it contains a polymer with which the PLA is copolymerised as the second component. The second component may be by itself or comprise a mixture of, for example, polyvinyl alcohol (PVA), polycaprolactone (PCL), polyethylene glycol (PEG), etc. Finally, PLA blends can be used, in which the PLA is mixed as a polymer with other polymers, for example polyolefins, for example polyethylene, as a PLA blend. The PLA can be present as PLA, PLA copolymer, PLA blend and mixtures thereof.

The PLA, PLA copolymer and/or PLA blend is present in a range of 50 to 80% by weight, preferably 55 to 70%, with respect to the shaft base material.

A consideration of the invention is that the base polymers used until now, in particular polystyrene or polystyrene-based polymers, are produced from petroleum-based starting materials. Consumers' concerns regarding the use of such petroleum-based starting materials are increasing because on the one hand, petroleum resources have to be used for it and on the other hand, the resulting material cannot be composted or is barely compostable. Both properties go against the current trend for promoting sustainable and/or environmentally-friendly products. In contrast, the invention proposes using PLA (polylactide polymers) as the base polymer, so that the use of petroleum-based raw materials in the pencil is significantly reduced or avoided completely. PLA, also generally known as polylactic acid, is obtained, for example, from renewable natural raw materials such as maize, for example, and belongs to the polyesters as a synthetic polymer. Thus, the pure PLA is preferably produced from renewable raw materials and is not based on fossil raw materials such as petroleum, for example.

In addition, PLA can be composted and, in particular in industrial composting units, can be decomposed within a manageable period of time, in particular less than 12 weeks, for example, into harmless end products, in particular in accordance with the EN 14995 or EN 13432 standards, wherein other similar standards can define other conditions and time periods. Industrial composting conditions are necessary the composting or for decomposition of PLA, i.e. controlled temperature and moisture conditions, in the presence of microorganisms. By way of example, in this regard, the temperatures must be 55 to 70° C. By means of industrial composting, it is possible to decompose the shaft of the pencil in accordance with the standard into harmless end products and to describe it as biodegradable. Special copolymers of the PLA and/or additional polymers can have a further specific influence on the biodegradable behaviour.

The mechanical properties of PLA can be adjusted to those of the known polystyrene by additives. The proposed composition of the shaft base material enables a shaft to be produced which has the required properties for pencils of sharpening capability, grip, mechanical, thermal and chemical stability. Thus, PLA forms a sustainable alternative to the base polymers used until now for the production of the pencil shaft.

It has been shown to be particularly advantageous when selecting the PLAs that, in particular compared with other plastics, the original properties such as sharpening capability, breaking strength, feel, for example, are not changed in a negative manner compared with the polymers from the prior art. Thus, the PLA in the cited and foamed formulation constitutes a valuable, sustainable substitute for the polymers which have been known until now.

In particular, the shaft base material is configured as a PLA blend and/or PLA copolymer. In the PLA blend, the PLA is mixed with one or more polymers. In the PLA copolymer, the PLA is polymerised with a further polymer.

PLA blends can be compatible mixtures with polyethylene glycol (PEG) and polypropylene glycol (PPG), for example, which in this case increase the flexibility of the PLA, which is brittle by itself. However, incompatible mixtures, for example with polyolefins (polyethylene PE, polypropylene PP), for example, are also possible in order to obtain specific properties. These are preferably produced from biological, sustainable sources such as, for example, from bioethanol or hydrogenated vegetable oils.

The biopolymer polybutylene succinate (PBS) can also be admixed with the above further polymers into the PLA/PLA copolymer. The PBS content here is 0 to 10% by weight, preferably with a proportion of less than or equal to 5% by weight, preferably less than or equal to 3% by weight and in particular less than or equal to 1% by weight, with respect to the shaft base material. This has the advantage that the brittle properties of the PLAs are somewhat reduced by the admixture of PBS. This means that the proportion of plasticizers can be reduced.

The further polymers in the PLA blend or PLA copolymer are present in the range 0 to 30% by weight, preferably 5 to 20% by weight, particularly preferably 7 to 15% by weight, with respect to the shaft base material.

### Plasticizers

In particular, the shaft base material has one or more plasticizers. In addition to copolymerisation in a polymer (internal plasticizing), the plasticizers can also be introduced in a solid, polymeric form or as a specific, oily, viscous substance into the base formulation (external plasticizing). As a rule, the plasticizing action here is obtained by the temperature treatment during granulation or extrusion.

In particular, polymeric plasticizers on a polyadipate basis (for example polybutylene adipate terephthalate (PBAT) (CAS 60961-73-1), but also other elastic polymer types such as polyethylene types, for example, or, generally, TPEs, may be mentioned.

Other external plasticizers include epoxidized vegetable oils such as, for example, epoxidized soya oil (ESBO) (CAS: 8013-07-8), but also citrate esters such as acetyltributyl citrate (ATBC) (CAS: 77-90-7). Furthermore, glycine triacetate (GTA) and diethylhexyl adipate (DOA) may be used alone, or in combination with the cited plasticizers. The plasticizers are present in a range of 0.1 to 25% by weight, preferably 5 to 20% by weight, particularly preferably 7 to 15% by weight, with respect to the shaft base material.

### Waxes, Lubricants

In order to obtain a suitable processability and in order to produce material-specific properties, optionally, different waxes and lubricants are added as a mixture. Inter alia, they may be PE waxes (grafted with maleic acid anhydride, for example), amide waxes, fatty acids such as stearic acid and palmitic acid, for example, montan waxes, stearates (for example Ca stearate), fatty acid esters, paraffin waxes, but also oils and fats such as palm oil, for example. The content of these auxiliary agents is between 0 and 10% by weight, preferably between 1 and 5% by weight.

For the sharpening capability, it is advantageous for the at least one wax to be selected from the group of waxes comprising amide waxes, fatty acids such as stearic acid and palmitic acid, for example, montan waxes, stearates, fatty acid esters, paraffin waxes. In addition, the wax comprises ethylene bis-stearamide, stearic acid, calcium stearate, polyethylene wax, maleic acid anhydride-grafted polyethylene wax.

### Other Additives

Other additives are used for different purposes depending on the rest of the formulation. Thus, adhesion promoters are used to bond incompatible polymers together, but possibly also as fillers. An example here is the coupling of PLAs with the aid of a maleic acid anhydride-grafted polyester. Furthermore, various stabilizers and/or also nucleation agents may be added. The amount of other additives depends on the quality and quantity of the rest of the components and is between 0 and 10% by weight, preferably between 1 and 5% by weight.

### Colorant

Colorants serve to adjust the desired aesthetic colour effect and should endow the shaft base material on the one hand with natural, (brown tones), or also on the other hand, with deliberately contrasting colours (black in cosmetic pencils). Preferably in this regard, thermally stable and physiologically suitable organic and/or inorganic pigments such as, for example, titanium dioxide, iron oxide, azo pigments, etc, are used. In order to lighten the shade, it has been shown to be advantageous for the white pigment to be titanium dioxide (TiO₂). To adjust the desired shade, it is advantageous for the shaft base material to contain 0.1 to 10% by weight of coloured colour pigment, for example iron oxide pigment, as part of the colorant. The exact content depends on the desired colouration and the colour-producing components (for example fillers) which are already present.

Colorants exist which also constitute fillers, such as graphite or carbon black, for example. The proportions of the shaft fillers are valid for coloured fillers.

### Fillers

In a preferred alternative or implementation of the invention, at least a portion of the shaft filler is selected to be an inorganic filler. By selecting the inorganic filler, the strength, brittleness and gliding properties upon sharpening can be adjusted, but also the material costs can be correspondingly reduced. Preferably, the at least one inorganic filler is from the group formed by phyllosilicates, in particular soapstone, talc, clay, kaolin, calcium carbonate, but also chalk, boron nitride, graphite, or a mixture thereof. Organic fillers such as wood flour and/or powdered cellulose are preferably used, because on the one hand they are inexpensive and promote the resemblance to wood, but on the other hand they also increase the proportion of biodegradable and renewable components in the formulation.

The shaft filler is preferably present in the range of 0 to 40% by weight, preferably 3 to 20% by weight, particularly preferably 4 to 13% by weight, with respect to the shaft base material.

In a preferred implementation of the invention, at least most of or even all of the shaft filler is selected to be an organic filler. So that the shaft has a character which resembles wood, preferably, the organic filler is selected from the group comprising wood and/or cellulose. As an example, wood flour may be used during the manufacture. For the sharpening capability, it is particularly advantageous for the at least one organic filler to be formed from particles of filler with a maximum particle size of 250 μm, in particular a maximum of 100 μm.

In a preferred implementation of the invention, at least most of or even all of the shaft filler is selected to be a mixture of the inorganic and organic fillers described above.

In particular, the shaft base material is free from colorants. As an alternative, the shaft base material has 1 to 3% by weight of white pigment as part of the colorant in order to lighten the shade of the shaft base material.

### Foaming Additives

The base formulation, in particular the PLA and the polymeric phase with the other additives, is foamed with the foaming additives. In the final state, the foamed shaft base material has pores which make the shaft main body lightweight and capable of being sharpened.

In this regard, the foaming additives are mixed into the base formulation and homogeneously distributed, in particular in the extruder or during injection moulding. When melting together in the extruder cylinder, when the respective decomposition point of the foaming additive is reached, a defined quantity of gas is released which is dispersed in the liquid phase of the plastic mixture. When the molten plastic mass exits the machine and when the extruded rod enters a cooling and calibrating device, the plastic matrix freezes and fixes the gas bubbles in the shaft base material.

Preferably, the process is carried out such that the pores are formed homogeneously in the whole of the shaft base material, in particular in the PLA and optional further polymers, and the pores cannot be seen on the shaft surface. As an alternative to this, the shaft base material with added foaming additives is sheathed in a decorative layer without foaming additives, so that the surface of the shaft base material is pore-free. In this regard, the decorative layer is ideally formed from polymers which are identical to or at least compatible with the shaft base material, so that a sufficient adhesion is produced.

On the one hand, the pores reduce the weight and the consumption of polymer. On the other hand, the shaft base material of the PLA becomes more elastic, so that the use of plasticizers can be reduced. Furthermore, because of the pores, the shaft base material of the resulting pencil can be sharpened with conventional sharpeners more easily. Furthermore, the reduction in density reduces the amount of material in the shaft base material and reduces costs. Densities of less than 1 g/cm³ are obtained in this regard. The addition of foaming additives implies the presence of pores in the extruded shaft base material. The quantity of foaming additives required depends on many factors such as, for example, the proportion of polymer, the quantity of filler, the dwell time and dwell temperature of the shaft base material in the extruder, etc., and is adjusted to between 1 and 10% by weight, preferably between 2 and 6%. As a rule, the foaming additives in this regard are added to the base formulation as what are known as masterbatches (substance/s or reactant/s embedded in a support material, usually a polymer) of the base formulation, in order to ensure an adequate miscibility. In this regard, preferably, physiologically harmless substances from the carbonates and/or citrates group are used, which mostly produce CO₂ as a gas and do not leave behind any reaction residues which are dangerous and/or harmful to health. The foaming additives which may be used here comprise carbonates or citrates. Examples of carbonates are ammonium carbonate, and alkali carbonate, such as sodium carbonate, potassium carbonate. Ammonium carbonate can be produced by adding calcium carbonate together with ammonium sulphate. Ammonium citrate, alkali citrates such as, for example, sodium citrate, potassium citrate, may be used as the citrates.

In a preferred embodiment of the invention, a major portion of the components are below the threshold conditions for the described industrial biological composting capability of the PLAS and so are co-compostable or are biobased from the outset or even of a natural origin, so that they do not have to be composted. This means that the shaft base material in its entirety can be decomposed biologically on an industrial scale or can be disposed of harmlessly. Particularly preferably, all of the components are below these limits.

In a possible further embodiment of the invention, a layer of adhesion promoter is disposed between the lead and the shaft. The adhesion promoter layer improves the bond of the shaft and the lead so that on the one hand, the sharpening capability is improved and on the other hand, fixing of the lead in the shaft is ensured. In particular, this option is used when mutually incompatible polymers are used in the shaft and lead. Preferably, maleic acid anhydride-grafted polylactic acid wax and/or an identical graft with another polyester is used as the adhesion promoter.

In a preferred further embodiment of the invention, the lead is also produced on the basis of PLA. In particular, the lead has PLA as the binder. Preferably, the lead is formed from the components as described in the document DE 10 2013 016 355 A1, the disclosure of which is incorporated by reference herein.

In particular, the lead has a lead base material. The lead base material is decisive for the industrial composting. The lead base material contains at least one binder with 10-40% by weight PLA. In particular, the lead base material has the following components:

| | |
|---|---|
| 10-40% by weight | PLA |
| 30-80% by weight | lead filler |
| 0-20% by weight | waxes/lubricants |
| 0-10% by weight | additives such as plasticizers, stabilizers, |
| | adhesion promoters, for example |

The proportion of polylactic acid in the lead composition is in the range of 10-60% by weight, preferably in the range of 10 to 40% by weight and particularly preferably in the range of 10-25% by weight.

It has been shown to be particularly advantageous for the polymer-bonded lead to contain

| | |
|---|---|
| 10 to 60% by weight | polylactic acid |
| 2 to 25% by weight | wax |
| 15 to 70% by weight | lead fillers |
| 0 to 5% by weight | palm oil |
| 0 to 30% by weight | colorant |

It has been shown to be successful for the at least one wax of the lead to be at least one from the group comprising fatty acids, stearates, montan waxes, amide waxes and paraffins. Mixtures of two or more waxes may also be used.

Particularly preferably in this regard, the at least one wax is calcium stearate and/or an ethylene-bis-stearamide (EBS) and/or PE wax. Very good results have been obtained by using ethylene-bis-stearamide (EBS) in coloured pencil leads. Very good results have been obtained by using calcium stearate in black pencil leads.

Advantageously, the at least one lead filler of the lead is formed by at least one filler from the group comprising graphite, hexagonal boron nitride, talc, soapstone, phyllosilicates (clays, kaolins), chalk.

For black pencil leads, in particular, graphite or graphite in combination with carbon black is particularly preferred as the colour-producing filler which, because of the high content, also constitutes the filler. For coloured pencil leads, combinations of white or colourless fillers such as talc, phyllosilicates, hexagonal boron nitride etc, with colour-producing pigments such as azo pigments, phthalocyanines, dioxazines, quinacridones, iron oxides, carbon black, graphite, ultramarine, iron cyanocomplexes, have been successful.

Colorants exist which constitute a lead filler at the same time. The proportions for coloured lead fillers are the same as for the lead fillers.

As an example, the filler for the lead is selected from the group comprising phyllosilicate and talc (coloured pencil) and graphite (black pencil).

In a preferred implement of the invention, the shaft base material and the lead base material are bonded together directly. In particular, these are bonded together in a material-bonding manner. An intermediate layer can advantageously be dispensed with by selecting PLA for the two base materials, because these identical polymers can bond to each other without further interventions. Thus, by selecting identical base materials, the adhesion promoter layer can be dispensed with and in addition, a stable bond can be formed.

In particular, the components of the lead are below the threshold conditions for the industrial biological compostability of PLAs and so are also co-decomposable or are bio-based, as already described above.

In a further constructive embodiment of the invention, the pencil is constructed as a writing pencil and/or painting pencil and/or cosmetic pencil. In particular, it may be produced as a black pencil or as a coloured pencil.

A shaft for writing implements, painting implements, drawing implements and/or cosmetic pencils constitutes further subject matter of the invention. The drawing implements are, for example, constructed as pen holders. Ball point pens or clutch pencils with movable leads, the shaft of which can be produced from the shaft base material with the base formulation, are considered to be writing implements.

In particular, the shaft base material for drawing implements can be constructed as described above. In particular, the base formulation for the shaft base material is constructed and/or produced in the same manner.

In particular, the shaft for writing implements, painting implements, drawing implements and/or cosmetic pencils has a shaft base material with a base formulation, wherein the base formulation comprises
50 to 80% by weight PLA, PLA copolymer and/or PLA blend
20 to 50% by weight further polymers, plasticizers, waxes/lubricants, other additives such as adhesion promoters, stabilizers, etc, colorants, in particular pigments, organic and/or inorganic fillers as shaft fillers.

The shaft base material is foamed and/or contains pores.

The shaft for writing implements, painting implements, drawing implements and/or cosmetic pencils contains a shaft base material with the same properties as the shaft base material described above.

A process for the production of the pencil and/or the shaft as described above or in accordance with one of the preceding claims constitutes further subject matter of the invention. In particular, the shaft is applied to the lead by primary shaping. In particular, extrusion, injection moulding or pressing may be used as primary shaping processes.

A production by means of extrusion can be carried out in a single stage as well as in two stages. In the case of the single-stage production, all of the pencil components (lead, any adhesion promoter layer, shaft base material and decoration) are thermoplastically shaped to near-net shape in a single tool and the geometry is frozen in during subsequent cooling processes.

In the case of the two-stage extrusion, firstly, shaping of the lead is carried out along with—if necessary—the optional adhesion promoter which is already located concentrically on the lead. In a further variation, the latter can also be applied to the shaft base material first. In a second step and in an additional tool, the lead rod obtained in this manner is then sheathed with the shaft base material and the decoration. After that, the procedure is identical to that single-stage variation.

Further features, advantages and effects of the invention will become apparent from the following description of preferred exemplary embodiments of the invention. In the figures:

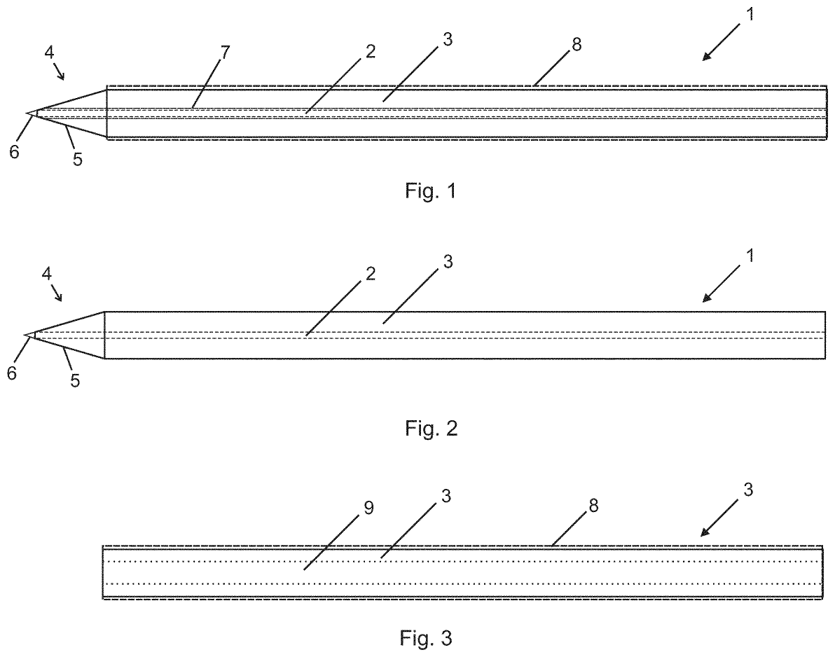

FIG. 1 shows a diagrammatic view of a pencil as an exemplary embodiment of the invention;

FIG. 2 shows a diagrammatic view of a further pencil as a further exemplary embodiment of the invention.

FIG. 1 shows a diagrammatic longitudinal section of a pencil 1, wherein the pencil 1 is constructed, for example, as a writing pencil, painting pencil, cosmetic pencil, black lead pencil or the like.

The pencil 1 has a lead 2 and a shaft 3, wherein the lead 2 is disposed in the shaft in a manner which is fixed against displacement relative to the shaft 3. In the exemplary embodiment, the lead 2 is coaxially and/or concentrically disposed in the pencil 1. The pencil 1 is cylindrical in construction, wherein its base area or cross sectional area can, for example, be circular, polygonal, oval, etc, in construction. In cross section, the lead 2 is circular in construction, for example. The shaft 3 has the external contour of the pencil 1 and the internal contour of the lead 2.

The pencil 1 is sharpenable and has a conical point 4 on one side, wherein a conical shaft section 5 of the shaft 3 transitions into a conical lead section 6 of the lead 2. The conical lead section 6 forms the point of the pencil 1. The conical point 4 can, for example, be produced by a separating or cutting procedure using a sharpener.

The shaft 3 has a shaft base material, wherein the shaft 3 is mainly formed from the shaft base material. Optionally, the pencil 1 can have further layers; in particular, an adhesion promoter layer 7, which forms an intermediate layer, can be disposed between the lead 2 and the shaft 3 in the pencil 1. As an alternative or in addition, a decorative layer 8 can be disposed on the outer circumference of the shaft 3.

Provision is made for the shaft base material to be produced on the basis of PLA. Exemplary compositions are provided below:

Example 1: Pencil or shaft with shaft base material which has the following base formulation:

| | |
|---|---|
| 80% by weight | PLA |
| 2.5% by weight | calcium stearate as wax |
| 1% by weight | PE wax as wax |
| 15% by weight | epoxidized vegetable oil as plasticizer |
| 0.5% by weight | iron oxide pigment as colorant |
| 1% by weight | TiO₂ as colorant |

The following is added for foaming:
5% by weight polymeric compound, containing the reactive components sodium bicarbonate/citric acid as the carbonate-based foaming additives.

Ex. 1 demonstrates a filler-free shaft with a high porosity and also a high composting capability or a high proportion of sustainable raw materials.

Example 2: Pencil or writing implement shaft with shaft base material which has the following base formulation as a PLA blend produced from PLA and PE:

| | |
|---|---|
| 65% by weight | PLA |
| 5% by weight | PE as further polymer |
| 5% by weight | PBAT as plasticizer |
| 10% by weight | ATBC as plasticizer |
| 2.5% by weight | MAH grafted PE wax as adhesion promoter |
| 1% by weight | MAH grafted PLA as promoter |
| 10% by weight | wood flour as organic filler, as shaft filler |
| 1.5% by weight | TiO₂ as colorant |

The following is added for foaming:
2% by weight polymeric compound, containing the reactive components sodium bicarbonate/citric acid as the carbonate-based foaming additives.

Ex. 2 is a wood-like shaft with a medium porosity. The proportion of wood of 10% by weight supports the sharpening capability and the proportion of natural, renewable raw materials in the formulation.

Example 3: Pencil or shaft with shaft base material which has the following base formulation as a PLA blend produced from PLA and PBS:

| | |
|---|---|
| 69% by weight | PLA |
| 6% by weight | PBS as further polymer |
| 4% by weight | talc as shaft filler |
| 5% by weight | epoxidized vegetable oil as plasticizer |
| 10% by weight | ATBC as plasticizer |
| 2.2% by weight | stearic acid as wax |
| 2.2% by weight | calcium stearate as wax |
| 0.3% by weight | iron oxide pigment as colorant |
| 1.3% by weight | TiO₂ as colorant |

The following is added for foaming:
2% by weight polymeric compound, containing the reactive component sodium bicarbonate as the carbonate-based foaming additive.

Ex. 3 provides a highly elastic shaft with a medium degree of foaming.

Example 4: Pencil or shaft with shaft base material which has the following base formulation:

| | |
|---|---|
| 55% by weight | PLA |
| 10% by weight | PBAT as plasticizer |
| 7% by weight | epoxidized vegetable oil as plasticizer |
| 2% by weight | ethylene bis-stearamide as lubricant |
| 2% by weight | PE wax as wax |
| 2.5% by weight | MAH grafted PLA as adhesion promoter |
| 20% by weight | wood flour as inorganic filler, as shaft filler |
| 0.1% by weight | iron oxide pigment as colorant |
| 1.4% by weight | TiO2 as colorant |

The following is added for foaming:
4% by weight polymeric compound, containing the reactive components sodium bicarbonate/citric acid as the carbonate-based foaming additives.

Ex. 4 provides a significantly more filled shaft with a high porosity.

Example 5: Cosmetic pencil or shaft with shaft base material which has the following base formulation as a PLA blend with PE:

| | |
|---|---|
| 45% by weight | PLA |
| 15% by weight | PE as further polymer |
| 20% by weight | PBAT as plasticizer |
| 4% by weight | epoxidized vegetable oil as plasticizer |
| 2% by weight | ATBC as plasticizer |
| 2% by weight | ethylene bis-stearamide as lubricant |
| 1% by weight | calcium stearate as wax |
| 10% by weight | chalk as inorganic filler, as shaft filler |
| 1% by weight | carbon black as colorant |

The following is added for foaming:
4.5% by weight polymeric compound, containing the reactive components sodium bicarbonate/citric acid as the carbonate-based foaming additives.

Ex. 5 provides a black-coloured and sharpenable cosmetic pencil with a high polymeric plasticizer content.

While in FIG. 1 a pencil 1 with a PLA-based shaft 3 and a conventional lead 2 is shown, wherein the adhesion promoter layer 7 is disposed between the lead 2 and the shaft 3, FIG. 2 shows a different exemplary embodiment.

In the exemplary embodiment in FIG. 2, the lead 2 is also produced on the basis of PLA, wherein this has a lead base material which contains at least 10% PLA.

Exemplary compositions are provided below:

### EXAMPLE 1: BLACK PENCIL LEAD

| | |
|---|---|
| 10 to 60% by weight | polylactide |
| 2 to 25% by weight | wax |
| 0 to 5% by weight | palm oil |
| Graphite | remainder |

Graphite is used in the examples as the colorant for black pencil leads. However, a combination of graphite and carbon black can also be used.

A composition for a coloured pencil lead comprises:

| | |
|---|---|
| 10 to 60% by weight | polylactide |
| 2 to 25% by weight | wax |
| 1 to 30% by weight | colorant |
| Remainder | fillers |

Coloured and/or non-coloured pigments may be used as the colour-producing agent in coloured pencil leads. Examples of such pigments are, inter alia, azo pigments, phthalocyanines, dioxazines, quinacridones, iron oxides, carbon black, graphite, ultramarine and iron cyanocomplexes.

Advantageously, in the exemplary embodiment in FIG. 2, the adhesion promoter layer 7 can be dispensed with, since both base materials are PLA-based and because the components are of the same type, they can bond together extremely well in a material-bonding and interlocking manner without the adhesion promoter layer 7.

In the case of pencil 1 in FIG. 1, at least the shaft 2 is compostable. Even though the further components might be more difficult to compost, this exemplary embodiment constitutes a great step towards a sustainable alternative for the pencil 1. In the exemplary embodiment of FIG. 2, both the shaft 2 as well as the lead 3 are compostable, so that this pencil 1 constitutes a sustainable alternative.

FIG. 3 diagrammatically shows a shaft 3 produced from the shaft base material with a void 9. An interchangeable, movable lead can be inserted into the void. Preferably, the lead can move in the void, as is the case, for example, with a ball point pen. The shaft 3 may constitute a section. Additional functional ends for limiting the movement of the lead, such as a tip or a push button, may be mounted at the ends of the shaft 3. As an example, the shaft 3 could be configured as a portion of a shaft 3 of a writing pencil, painting pencil, ball point pen, cosmetic pencil, black pencil, retractable pencil or the like. As an alternative or in addition, a decorative layer 8 may be disposed on the outer circumference of the shaft 3.

### LIST OF REFERENCE SYMBOLS

1 pencil
2 lead
3 shaft
4 conical point
5 conical shaft section
6 conical lead section
7 adhesion promoter layer
8 decorative layer
9 void

1. A pencil,
with a shaft,
wherein the shaft has a shaft base material with a base formulation,
wherein the base formulation comprises

| | |
|---|---|
| 50 to 80% by weight | PLA, PLA copolymer and/or PLA blend |
| 20 to 50% by weight | further polymers, plasticizers, waxes/ |
| | lubricants, other additives such as adhesion |
| | promoters, stabilizers, etc, colorants, in |
| | particular pigments, organic and/or inorganic |
| | fillers, as shaft fillers, |

wherein the shaft base material is foamed and/or contains pores.

2. The pencil as claimed in claim 1, characterized in that a production mixture is used for the production of the shaft base material, wherein the production mixture contains

| | |
|---|---|
| 90 to 99% by weight | base mixture with the base formulation |
| 1 to 10% by weight | foaming additives. |

3. The pencil (1) as claimed in claim 1, characterized in that the base formulation comprises the following proportions of the components:

| | |
|---|---|
| 50 to 80% by weight | PLA, PLA copolymer and/or PLA blend |
| 0 to 10% by weight | polybutylene succinate (PBS) |
| 0 to 25% by weight | further polymers, apart from PBS |
| 0 to 25% by weight | plasticizers |
| 0 to 10% by weight | waxes/lubricants |
| 0 to 10% by weight | other additives such as adhesion promoters, |
| | stabilizers, etc |
| 0 to 10% by weight | colorants, in particular pigments |
| 0 to 40% by weight | organic and/or inorganic fillers as shaft |
| | fillers. |

4. The pencil as claimed in claim 1, characterized in that the PLA is biobased and/or at least the majority or the entirety of the shaft filler is organic.

5. The pencil as claimed in claim 1, characterized in that the shaft filler is selected from the group comprising wood and cellulose.

6. The pencil as claimed in claim 1, characterized in that the shaft filler comprises an inorganic filler component, wherein the inorganic filler component is preferably from the group formed by phyllosilicates, in particular soapstone, clay, kaolin, talc, and/or from chalk, graphite, boron nitride.

7. The pencil as claimed in claim 1, characterized in that the pencil has a lead, wherein the lead is disposed in the pencil and/or shaft in a manner which is resistant to displacement.

8. The pencil as claimed in claim 7, characterized in that a layer of adhesion promoter is disposed between the lead and the shaft.

9. The pencil as claimed in claim 7, characterized in that the lead contains a lead base material, wherein the lead base material contains at least one binder with 10-40% by weight PLA.

10. The pencil as claimed in claim 9, characterized in that the shaft base material and the lead base material are directly bonded together without a separate adhesion promoter layer.

11. The pencil as claimed in claim 1, characterized in that it is constructed as a writing pencil and/or painting pencil and/or as a cosmetic pencil.

12. A shaft for writing implements, painting implements, drawing implements and/or cosmetic pencils, wherein the shaft has a shaft base material with a base formulation,
wherein the base formulation comprises

| | |
|---|---|
| 50 to 80% by weight | PLA, PLA copolymer and/or PLA blend |
| 20 to 50% by weight | further polymers, plasticizers, waxes/ |
| | lubricants, other additives such as |
| | adhesion promoters, stabilizers, etc, |
| | colorants, in particular pigments, |
| | organic and/or inorganic fillers, |
| | as shaft fillers, |

wherein the shaft base material is foamed and/or contains pores.

13. A process for the production of the pencil as claimed in one of claim 1 and/or of the shaft as claimed in claim 12, characterized in that a base mixture with the base formulation and the foaming additives are mixed and thermally treated in order to produce the foamed shaft material, wherein the base formulation comprises

| | |
|---|---|
| 50 to 80% by weight | PLA, PLA copolymer and/or PLA blend |
| 20 to 50% by weight | further polymers, plasticizers, waxes/ |
| | lubricants, other additives such as |
| | adhesion promoters, stabilizers, etc, |
| | colorants, in particular pigments, |
| | organic and/or inorganic fillers, |
| | as shaft fillers. |
